(19) United States
(12) Patent Application Publication
(10) Pub. No.: US 2011/0070083 A1
(43) Pub. Date: Mar. 24, 2011

(54) Streamlined Wind Turbine Optimized for Laminar Layer

(76) Inventor: Salomo Murtonen, Pasadena, CA (US)

(21) Appl. No.: 12/885,357

(22) Filed: Sep. 17, 2010

Related U.S. Application Data
(60) Provisional application No. 61/244,039, filed on Sep. 19, 2009.

(51) Int. Cl. F03D 1/06; F03D 7/02; F03D 11/00

(52) U.S. Cl. 416/9; 416/244 R; 416/84

(57) ABSTRACT

A wind turbine body and a wind turbine are disclosed. The wind turbine body has a curved body and a plurality of blades. The curved body includes a front portion, a rear portion, and a middle portion between the front portion and the rear portion. The curved body is configured such that at least the middle portion rotates about an axis of rotation. A diameter of the curved body gradually increases from the front portion to the middle portion, and gradually decreases from the middle portion to the rear portion. The blades are attached to and around the middle portion about the axis of rotation. The blades are configured to convert an airflow into rotational motion of the middle portion. The wind turbine includes a wind turbine body and a fin at the rear portion. The fin is configured to steer the wind turbine about a steering axis so that the front portion faces the airflow.

### CROSS-REFERENCE TO RELATED APPLICATION(S)

This application claims priority to and the benefit of U.S. Provisional Patent Application No. 61/244,039, entitled “Streamlined Wind Turbine Optimized for Laminar Layer,” filed on Sep. 19, 2009, the entire content of which is incorporated herein by reference.

### BACKGROUND

1. Field

Embodiments of the present invention relate to the field of wind turbines and fluid turbines for converting one form of energy (for example, an airflow energy) into another form of energy.

2. Description of the Related Art

Wind power is capable of being converted to mechanical energy by using wind turbines. Average wind speeds in most parts of the world, however, are insufficient to make efficient use of existing wind turbine technology. Conventional wind turbines, with long blades capable of spinning at speeds of 200 miles per hour, are also a serious hazard to birds.

With increased demand for cleaner sources of energy, such as wind-powered turbines, it is desirable to provide an efficient wind turbine capable of delivering reasonable amounts of power in average wind speed environments. It is also desirable to have a wind turbine that is less dangerous to native bird populations.

### SUMMARY

Embodiments of the present invention address these problems through a wind turbine body design that directs the airflow in such a manner so as to significantly increase its velocity before it reaches the blades. This, combined with numerous short blades, allows these embodiments to harness significant amounts of wind energy (which in turn can lead to significant amounts of electric power) even in average wind speed environments (and with significantly less risk to native bird populations).

As illustrated in FIG. 13, increasing average wind speed by 1.5 times to 2 times makes a shift of the wind speed curve to the right (curves 1330 and 1340). In a fixed speed wind turbine (for example, a direct drive wind turbine, that is, one without gearboxes), the fixed speed wind turbine's revolutions per minute (RPM) is the same as its generator's RPM. Thus, curve 1320 also represents a fixed speed wind turbine generator coefficient curve. This right-hand shift extends the practical wind speed range for small-scale wind turbine technology to allow it to harness wind power more efficiently during average conditions.

Various configurations are provided, including single or multiple bodies, stationary or floating, where some or all of the body rotates in response to an airflow directed at the body. Fixed body portions may also be used for advertising, while rotating portions may, for example, have synchronized lights. The body can be any size. The embodiments of the present invention can also be applied to media other than wind, such as fluids, streams, etc.

In an exemplary embodiment according to the present invention, a wind turbine body is disclosed. The wind turbine body includes a curved body and a plurality of blades. The curved body includes a front portion, a rear portion, and a middle portion between the front portion and the rear portion. The curved body is configured such that at least the middle portion rotates about an axis of rotation. A diameter of the curved body gradually increases from the front portion to the middle portion, and gradually decreases from the middle portion to the rear portion. The blades are attached to and around the middle portion about the axis of rotation. The blades are configured to convert an airflow energy into rotational motion energy of the middle portion.

The curved body may be sphere shaped.

The curved body may be torpedo shaped.

The curved body may be teardrop shaped.

The curved body may be inflatable.

The curved body may be configured to be filled with lighter-than-air gas and the middle portion may be configured to rotate while floating.

The curved body may be configured to attach to a pole.

The wind turbine body may further include an axle along the axis of rotation.

The axle may be configured to attach to a supporting frame.

The wind turbine body may further include the supporting frame.

The supporting frame may be configured to attach to a pole.

Each of the blades may have a height in a radial direction of the axis of rotation that is substantially equal to a thickness of a laminar layer at the middle portion.

Each of the blades may have a shape of an airfoil.

According to another exemplary embodiment of the present invention, a wind turbine is disclosed. The wind turbine includes a wind turbine body and a fin. The wind turbine body includes a curved body and a plurality of blades. The curved body includes a front portion, a rear portion, and a middle portion between the front portion and the rear portion. The curved body is configured such that at least the middle portion rotates about an axis of rotation. A diameter of the curved body gradually increases from the front portion to the middle portion, and gradually decreases from the middle portion to the rear portion. The blades are attached to and around the middle portion about the axis of rotation, and configured to convert an airflow energy into rotational motion energy of the middle portion. The fin is at the rear portion and configured to steer the wind turbine about a steering axis so that the front portion faces the airflow.

The curved body may be teardrop shaped.

The curved body may be configured to be filled with lighter-than-air gas and the middle portion may be configured to rotate while floating.

The curved body may be configured to attach to a pole along the steering axis.

The wind turbine may further include an axle located along the axis of rotation.

The axle may be configured to attach to a supporting frame.

The wind turbine may further include the supporting frame.

The supporting frame may be configured to attach to a pole along the steering axis.

Each of the blades may have a height in a radial direction of the axis of rotation that is substantially equal to a thickness of a laminar layer at the middle portion.

Each of the blades may have a shape of an airfoil.

In yet another exemplary embodiment according to the present invention, a wind turbine is disclosed. The wind turbine includes a plurality of wind turbine bodies, an interconnecting frame for connecting the wind turbine bodies, and a fin. The wind turbine bodies are for converting an airflow into rotational motion. Each of the wind turbine bodies includes a curved body and a plurality of blades. The curved body includes a front portion, a rear portion, and a middle portion between the front portion and the rear portion. The curved body is configured such that at least the middle portion rotates about an axis of rotation. The diameter of the curved body gradually increases from the front portion to the middle portion, and gradually decreases from the middle portion to the rear portion. The blades are attached to and around the middle portion about the axis of rotation. The blades are configured to convert the airflow into rotational motion of the middle portion. The fin is configured to steer the wind turbine about a steering axis so that the front portion of each of the wind turbine bodies faces the airflow.

The fin may be located on the interconnecting frame.

The wind turbine bodies may be all of a same shape and size.

The shape may be a teardrop.

The curved body of each of the wind turbine bodies may be configured to be filled with lighter-than-air gas and the middle portion of each of the wind turbine bodies may be configured to rotate while floating.

The frame may be configured to attach to a pole along the steering axis.

Each of the wind turbine bodies may further include an axle along its respective axis of rotation.

The axle of each of the wind turbine bodies may be attached to the interconnecting frame.

Each of the blades may have a height in a radial direction of its respective axis of rotation that is substantially equal to a thickness of a laminar layer of its respective curved body at the middle portion.

Each of the blades may have a shape of an airfoil.

### BRIEF DESCRIPTION OF THE DRAWINGS

The accompanying drawings illustrate embodiments of the present invention, and together with the description, serve to explain the principles of the embodiments of the present invention.

FIG. 1 depicts an exemplary wind turbine according to an embodiment of the present invention.

FIGS. 2-4 show wind turbines having different body and blade shapes according to other embodiments of the present invention.

FIG. 5 shows the laminar flow of an airflow about the wind turbine of FIG. 1.

FIG. 6 depicts an embodiment of the present invention with a wind turbine body that includes a rotating nose and a fixed tail.

FIG. 7 shows an embodiment of the present invention with a fixed nose and tail along with a rotating belt of blades.

FIG. 8 shows an embodiment of the present invention with a fixed nose and a rotating tail.

FIGS. 9-10 depict wind turbine embodiments of the present invention with multiple bodies.

FIG. 11 illustrates a lighter-than-air embodiment of the present invention.

FIG. 12 shows an example system according to an embodiment of the present invention.

FIG. 13 shows annual wind speed frequency distribution from a location of average wind speeds along with a coefficient curve of a conventional fixed speed (without gear boxes) wind turbine generator.

FIG. 14 illustrates the relationship of the amount of torque generated by the blades of a conventional three-blade wind turbine as a function of the distance from the axis of rotation.

FIG. 15 illustrates the relationship of the amount of torque generated by the blades of an exemplary wind turbine embodiment of the present invention as a function of the distance from the axis of rotation.

### DETAILED DESCRIPTION

The illustrative embodiments that follow are only exemplary applications of the present invention and not intended to limit the scope of the invention. In the drawings, like reference numerals denote like structures throughout.

Wind power is capable of being converted to mechanical energy by using wind turbines. This mechanical energy can then be converted to other forms of energy (for example, heat exchange, gravity, generator, pump, and the like). While wind power may offer an attractive source of clean energy, average wind speeds and existing wind turbine technology limit its applicability. According to a study by Cristina Archer and Mark Jacobson from Stanford University “Evaluation of Global Wind Power,” the global average 10 meter altitude wind speed over land is 3.28 m/s (meters per second), while the 80 meter altitude (typical for 77 m diameter conventional wind turbines) wind speed over land is only slightly better, namely 4.54 m/s. Neither of these speeds is sufficient for efficient use of conventional wind turbines.

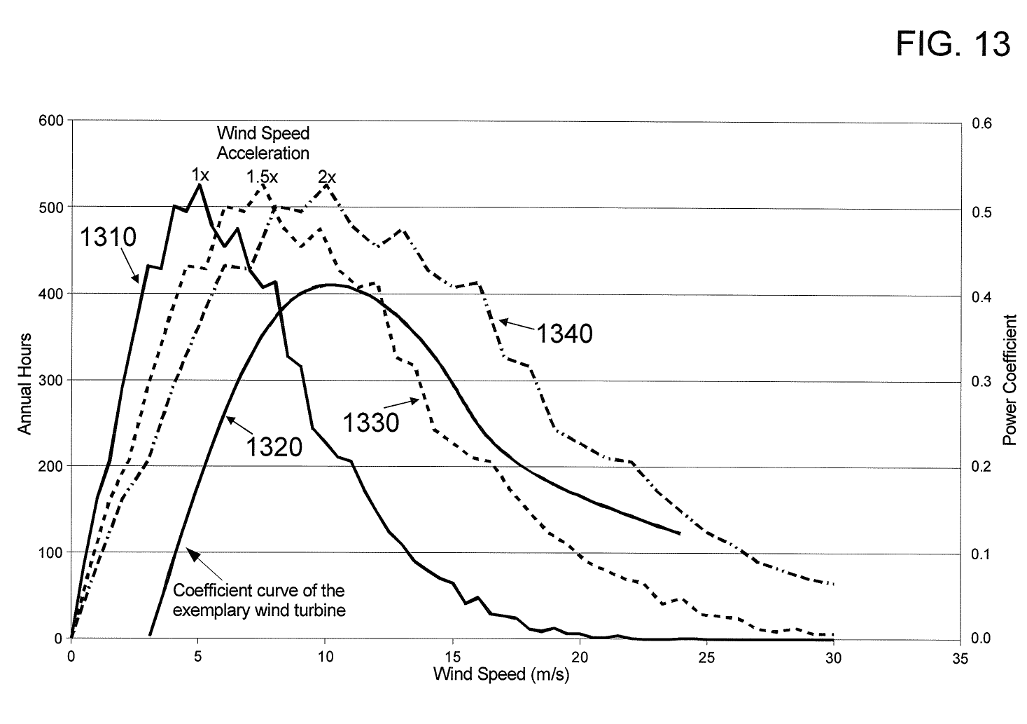

FIG. 13 shows annual wind speed frequency distribution (in hours) from a location of average wind speeds along with a coefficient curve of a conventional fixed speed (e.g., direct drive) wind turbine generator.

Referring to FIG. 13, curve 1310 shows annual wind speed frequency distribution (in meters per second, or m/s, along the horizontal axis, and in hours along the vertical axis) at Lee Ranch (data is provided by Sandia National Laboratories New Mexico Wind Resource Assessment Lee Ranch Annual Analysis for January-December 2002). Curve 1320 is the coefficient curve representing conventional small-scale fixed speed (e.g., direct drive, without gearboxes) wind turbine generators (in m/s along the horizontal axis, and in power coefficient along the vertical axis). As can be seen from FIG. 13, the average wind speed is about 5 m/s, while most of the wind energy captured by the conventional turbines is in the wind speed range of 8-15 m/s, with very little energy produced at wind speeds of 5 m/s or lower. Thus, wind energy at closer to average conditions represents a large untapped resource.

For illustration purposes, curve 1310 is also depicted in curve 1330 at 1.5 times the average wind speed and in curve 1340 at 2 times the average wind speed. Comparing these faster wind speed curves to the coefficient curve 1320, it can be seen that in order for conventional wind turbines to operate as efficiently as they are capable, wind speeds more like 1.5 or 2 times the average wind speed are necessary.

An efficient conventional three-blade wind turbine extracts less than one-half of the kinetic energy at the optimal wind speed. However, during the spinning process, the blade tips can shed vortex and create swirl wakes, causing energy loss. Most of the torque generated from conventional wind turbines comes from the tip areas of the blades, which can attain speeds as high as 200 miles per hour (on a side note, these large, high speed blades can be lethal to birds that stray in their path). That is why conventional blades are so long, in order to generate as much torque as possible. Meanwhile, the shaft end of the blade next to the center hub travels very little compared to the blade tip. Thus, the shaft end contributes very little in the way of torque.

To harness more power using a conventional three-blade wind turbine, it is necessary to either install it at a higher altitude to catch faster wind speed or extend the wind turbine blades (that is, make them longer) to capture a larger wind area. Extending the blades, however, may easily cause breakdown of the blades due to increased centrifugal force and stress on the blades. It may also require more wind speed to operate since longer blades are likely to be heavier and harder to rotate.

In addition to the limitations of the regular turbine structure itself, having access to the useful wind speed is another challenge. It is generally acknowledged that at least a wind speed of five meters per second, or about eleven miles per hour, is required in order to make energy recovery economically feasible using a conventional wind turbine. In vast urban areas, where energy is needed most, it is not feasible to do so due to the low wind speed.

It is well known that captured power=torque×RPM, and torque=force(lift)×radius. Further, lift can be expressed as

lift=coefficient of lift×0.5×air density×blade surface area×(air velocity)²×number of blades

Increasing torque and/or RPM will enhance the ability of capturing more power. Embodiments of the present invention address areas of both increasing wind speed (RPM) and increasing torque.

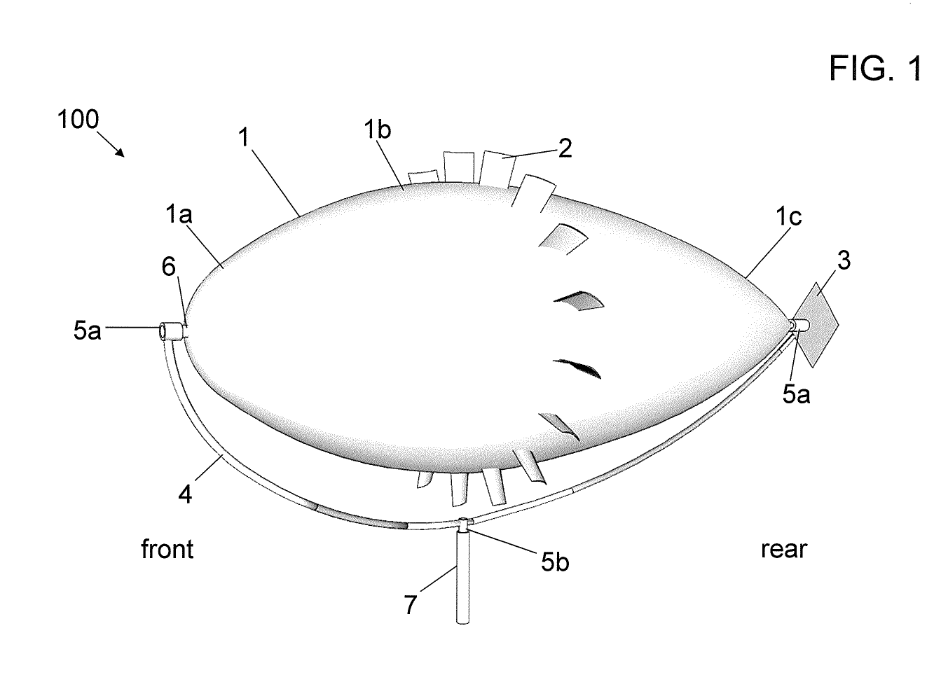

Based on Bernoulli's Principle, air flowing over a curved object travels faster than air flowing over a straight surface. The disclosed wind turbine in exemplary embodiments is built with a body having a curved shape, such as teardrop, sphere, or torpedo, to force oncoming wind to go around the body about an axis of rotation. See, for example, axle 6 in FIG. 1, which extends between bearings 5a (or other suitable methods or devices to permit rotation about the axis of rotation) on both ends of the wind turbine 100. Embodiments of the disclosed wind turbine include a large number of relatively short blades (compared to a conventional three-blade wind turbine) on the body. The blades are configured all around a middle portion of the body (where the laminar flow is greatest) about the axis of rotation. In some embodiments, the blades have an airfoil shape, to generate lift, which helps spin them faster.

In addition, in some embodiments, a relatively fixed (i.e., does not rotate about the axis of rotation) rear (tail) fin (or vane) is employed to steer the wind turbine, keeping the front pointed to face the wind. In other embodiments, the shape of the body or the location of a steering axis (e.g., at or in front of the center of gravity) may be sufficient to keep the front pointed to face the wind. For instance, in other configurations, the fin may not provide any benefit due to the body's streamline shape. That is, the body may turn to face the wind by itself in order to encounter the least turbulence, and not need any assistance from a tail fin.

The middle portion of the wind turbine body is between a front portion and a rear portion, with at least the middle portion (and the blades) configured to rotate, to generate as much torque as possible. See, for example, FIGS. 1-4, for exemplary wind turbines.

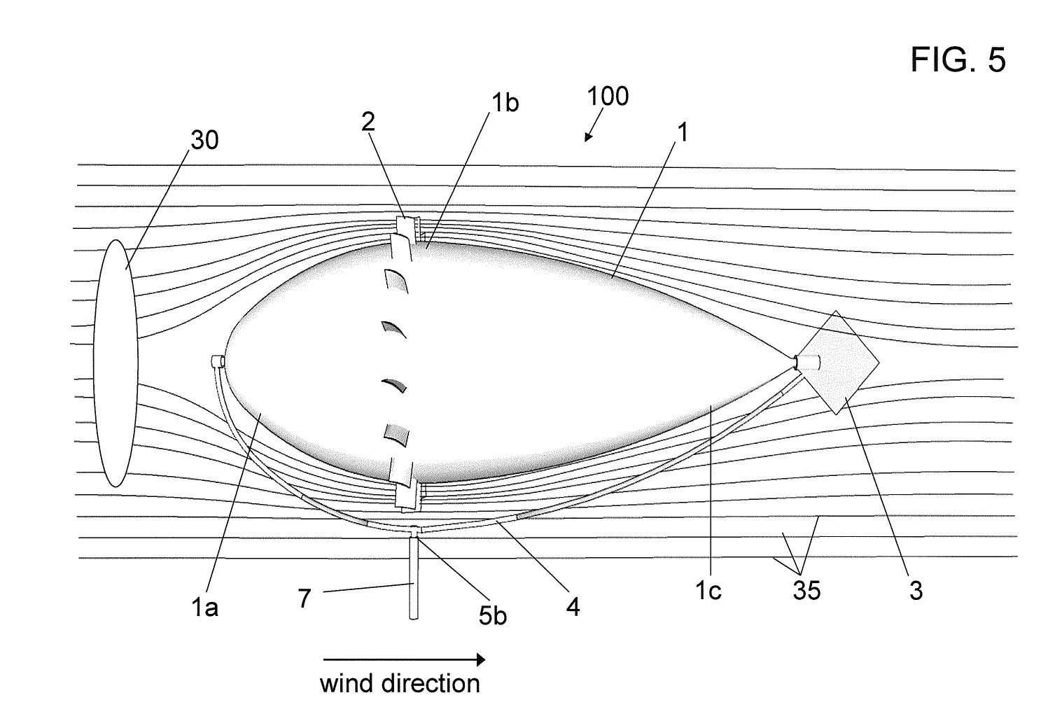

To effect efficient wind turbine rotation, a set of blades is placed around the teardrop body where the accelerated laminar flow is located (which, for purposes of this disclosure, will be referred to as the “middle portion” of the body). Unlike a conventional three-blade wind turbine, there may be considerably more blades in embodiments of the present invention (to contact as much of the laminar flow as possible), and they may be considerably shorter (in the radial direction), as the laminar flow is the main source of power and only extends a short distance from the body. See, for example, the exemplary wind turbine 100 in FIG. 5. This contoured laminar flow directs the concentrated and faster wind flow to blade tips 2, which results in increased wind turbine rotation speed. However, as the most efficient power generation occurs in conventional wind turbines at wind speeds between 7 m/s and 15 m/s (referring to coefficient curve 1320 in FIG. 13), embodiments of the present invention can accelerate the oncoming wind speed in the laminar flow region by 1.5 times (see curve 1330 in FIG. 13) to 2 times (see curve 1340 in FIG. 13), shifting the wind speed curve to the right to match the turbine's rotational speed with the optimal generator's RPM (curve 1320).

Unlike the conventional wind turbine, the disclosed wind turbine in exemplary embodiments forces oncoming airflow to contour along its curved (for example, teardrop) shaped body. The streamlined air in direct contact with the teardrop body forms a thin layer of laminar flow surrounding its body, and travels at accelerated speed according to Bernoulli' Principle. Its trailing tail reduces air drag, making the wind turbine more stable under higher wind speed. See, for example, FIG. 5, which shows an example laminar flow about an exemplary wind turbine 100. In FIG. 5, air cross-section 30 depicts the cross section of air approaching the wind turbine 100. Airflow lines 35 depict the flow of air (which moves from left to right, or “leading” to “trailing”) about the wind turbine 100.

Other techniques can also be used to reduce drag, which can lead to more efficient operation of exemplary wind turbine embodiments of the present invention. For instance, in some embodiments, airfoil-shaped blades are used to generate “lift” and reduce drag. In other embodiments, the wind turbine body is dimpled (like, for example, a golf ball), which is also a known technique for reducing drag. The dimpling, for instance, can be applied to any curved portion of the body's shape, such as the front or the back of the wind turbine body.

The teardrop body shape of wind turbine 100 forces the oncoming air (in cross section 30, the leading airflow) to flow around the body 1, starting at a front portion 1a (which faces the wind), then increasing velocity as the body expands to a middle portion 1b, which is configured to rotate and is where the airflow contacts the blades 2 of the wind turbine 100. The laminar layer around body 1 speeds up at the blade 2 area, where air pressure is the lowest, and expands after passing the middle portion 1b while traveling towards the rear portion 1c, thus normalizing air pressure to ambient level based on Bernoulli's Principle. In this way, air turbulence and air drag around the rear portion 1c is reduced or minimized. Trailing fin 3 steers the body 1 to point in the correct orientation to face the wind.

It should be noted that other methods or devices can be used to direct the wind turbine to face the wind (i.e., not just the tail fin). For example, in another embodiment, a motor is used to direct the wind turbine, with a wind sensor to control the motor. In another exemplary embodiment, the wind turbine body is positioned on a steering axis that is forward of the body's center of gravity, thus favoring the lighter (front) portion to face an oncoming wind. In still another embodiment, no automatic method or device is provided to compensate for changing wind directions. That is, the wind turbine faces the same direction until manually adjusted to face another direction. This can be useful, for example, in areas where the winds tend to come from one direction, or when manual adjustment is sufficient for the intended purpose. Further embodiments of the present invention may face oncoming wind automatically (without a tail fin) in order to find the lowest drag position. For example, a body shape with a more tapered trailing portion than leading portion will tend to face the wind when pivoting on a steering axis located at the center of gravity of the body, even in the absence of a tail fin.

The shape and orientation of the fin 3 also causes the body 1 to redirect itself about a steering axis (see, for example, pole 7, working in conjunction with bearings 5b and frame 4) to a change in the direction of the airflow so that the front portion 1a continues to face the airflow. For example, a flat diamond-shaped vertical plate 3 depicted in FIG. 5 in the same plane formed by the axis of rotation and the steering axis helps steer the body 1 about the steering axis to face the leading airflow by catching trailing airflow when the front portion 1a does not face the leading airflow, thus turning the front portion 1a in the direction of the airflow. In other embodiments, the tail fin can be other shapes. It should be noted that the fin 3 is not configured to rotate about the axis of rotation.

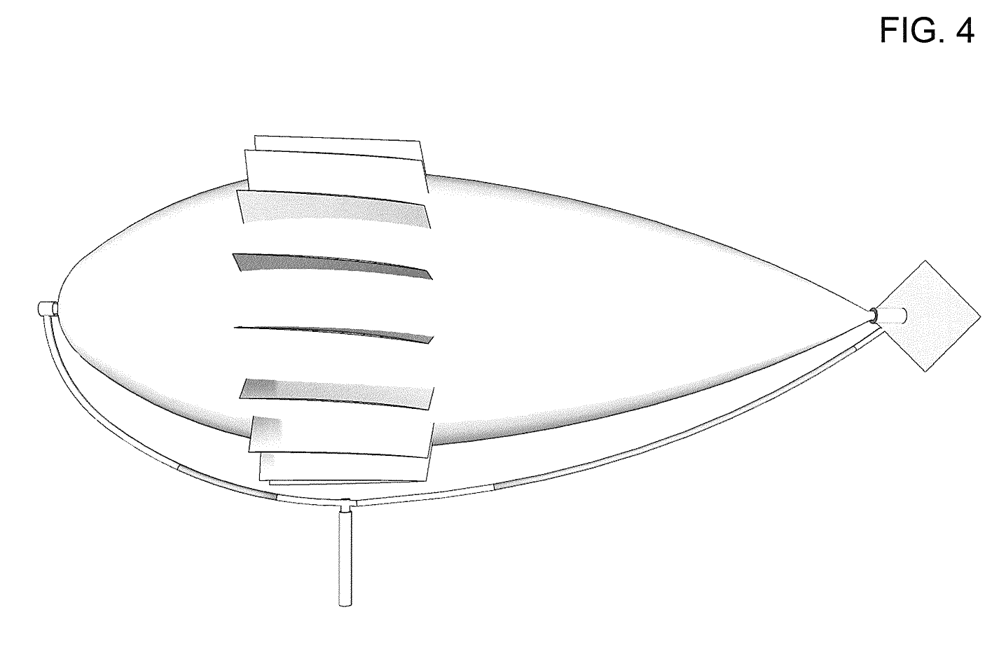

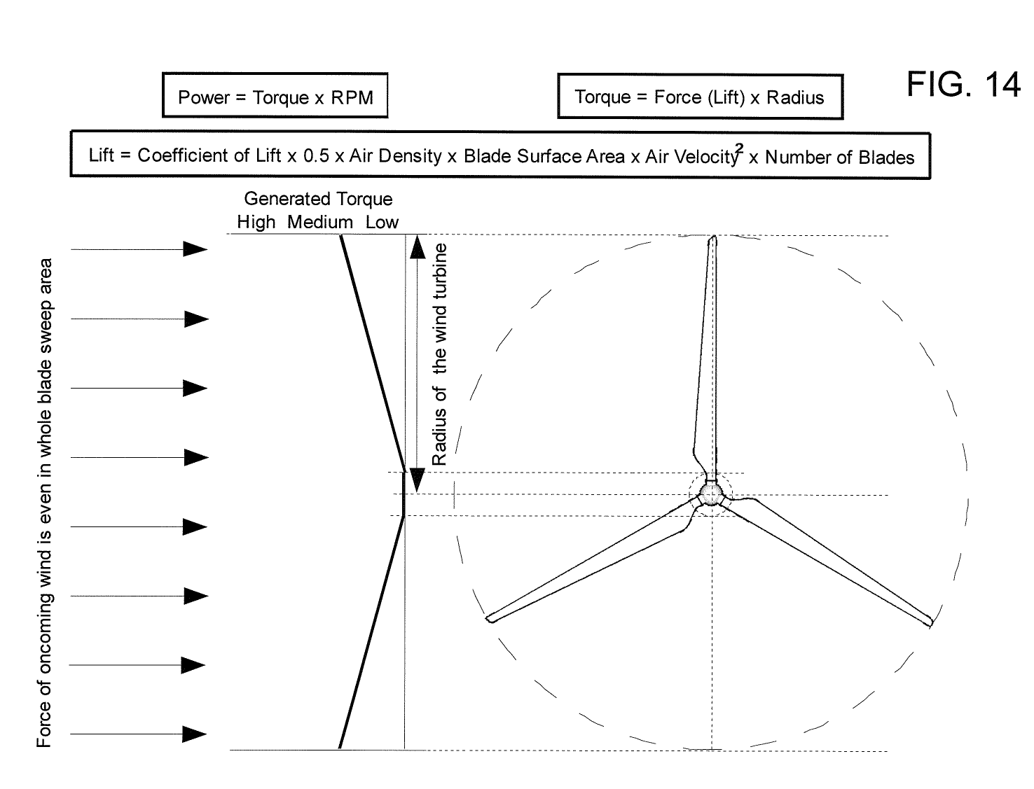

In addition, in order to harvest more energy from the surrounding laminar layer, multiple blades with extra width may be installed (see, for example, FIG. 4) to increase the generator torque (recalling that Torque=Radius×force). Compared with the three-bladed conventional wind turbine with the same dimensions (where torque is increased proportionally as the blade radius increases under the same condition of air force), the optimal torque can be reached at the furthest tip area of the blade only if all the force in the swept area is directed to the blade tip (which does not take place). See, for example, FIG. 14, which illustrates the relationship of the amount of torque generated by the blades of a conventional three-blade wind turbine as a function of the distance from the axis of rotation.

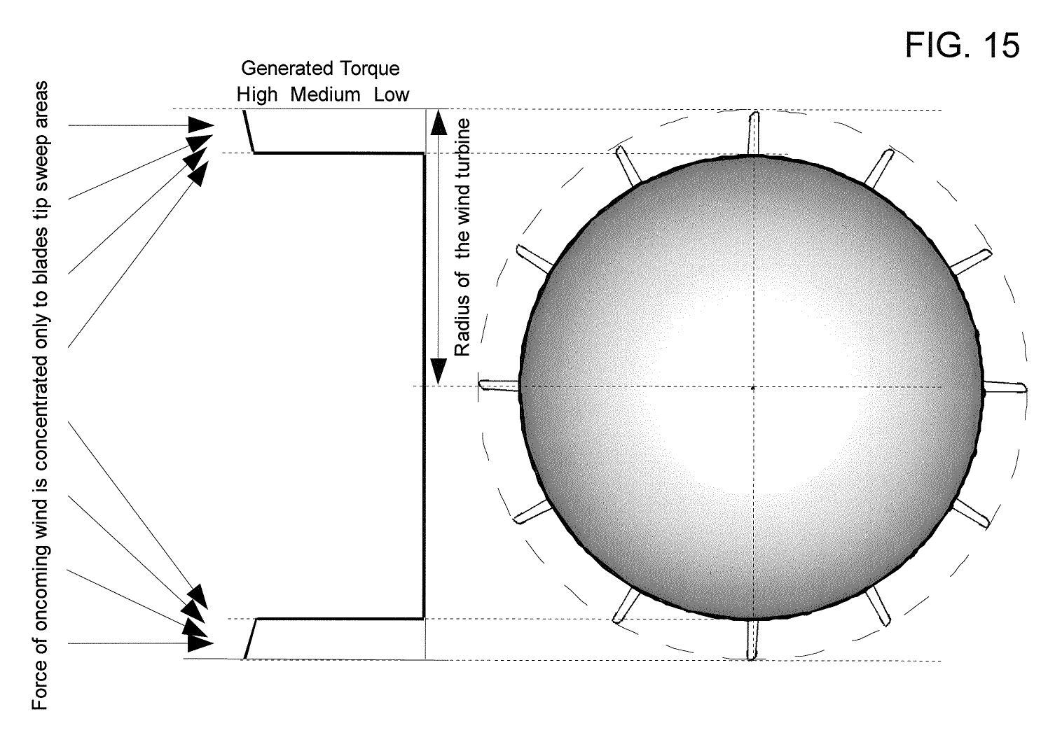

With embodiments of the present invention, however, the streamlined shape body directs and concentrates the wind force to the tip area of multiple blades. Thus, extra torque is generated in embodiments of the present invention when compared to conventional wind turbines. See, for example, FIG. 15, which illustrates the relationship of the amount of torque generated by the blades of an exemplary wind turbine embodiment of the present invention as a function of the distance from the axis of rotation (comparing with a similar depiction for that of a conventional wind turbine in FIG. 14). Similarly, the wider the airfoil-shaped blade, the stronger the lift effect and thus, the higher the resulting torque. Herein, when referring to the blade shape of the blades attached to a wind turbine body, “length” refers to the direction radial to the axis of rotation while “width” refers to the direction parallel to the axis of rotation.

The building material of the parts of the wind turbine (for example, the body, the blades, and the tail fin) may vary based on a user's needs (such as weight, cost, or efficiency). For instance, they can be metal, fabric, plastic, Styrofoam, wood, carbon fiber, fiberglass, etc. The body can be inflatable, for example, to keep costs down, and it helps build pressure to better define and maintain the desired shape. Inflatable bodies can also be filled with lighter-than-air gas (for example, helium) to reduce weight or make them float in air.

The body can be any size. Smaller sizes can be easier to build and maintain the desired shape, but do not catch as much wind as larger sizes. While, for the same body shape, the amount of wind cross-section grows as the square of the linear dimension (for example, diameter), the size of the body grows as the cube of the linear dimension. Thus, while larger bodies may be more efficient to operate (since they capture more wind energy), they may become impractical to build at some point because of considerations like weight and structural integrity. Inflatable bodies may be capable of larger sizes than non-inflatable bodies because of such considerations.

The blades can be any sturdy material (for instance, airplane-like material) configured to turn the body in one direction (for example, an airfoil). Their length is relatively short as the laminar layer (from which the wind turbine obtains most of the wind energy) does not extend far from the body, so additional length would only serve to slow down the wind turbine (i.e., generate less torque). For example, in an embodiment, the blade length may be one quarter of the body diameter. In another embodiment, the blade length may be less than one quarter of the body diameter. In yet another embodiment, the blade length may be equal to or substantially equal to a thickness of the laminar layer of the body at its middle portion.

The curvature of the blades should be consistent (in, for example, an airfoil shape), which can help to provide “lift” to spin the body, reduce air drag, minimize turbulence, and not disturb the laminar layer. According to body designs of exemplary embodiments of the present invention, numerous blades (see, for example, exemplary wind turbines depicted in FIGS. 1-12) can be added to increase torque, whereas on the conventional turbine, the number of blades is limited due to factors such as the size of the turbine hub.

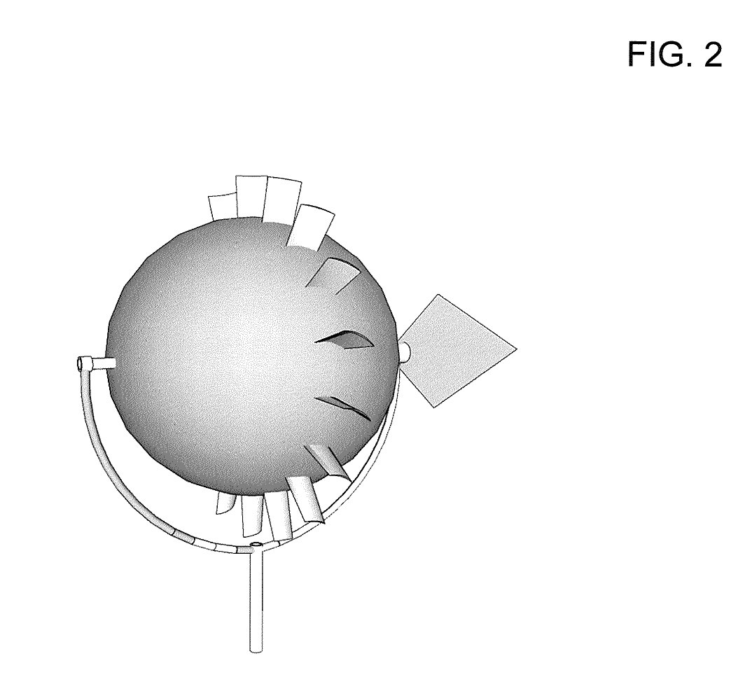

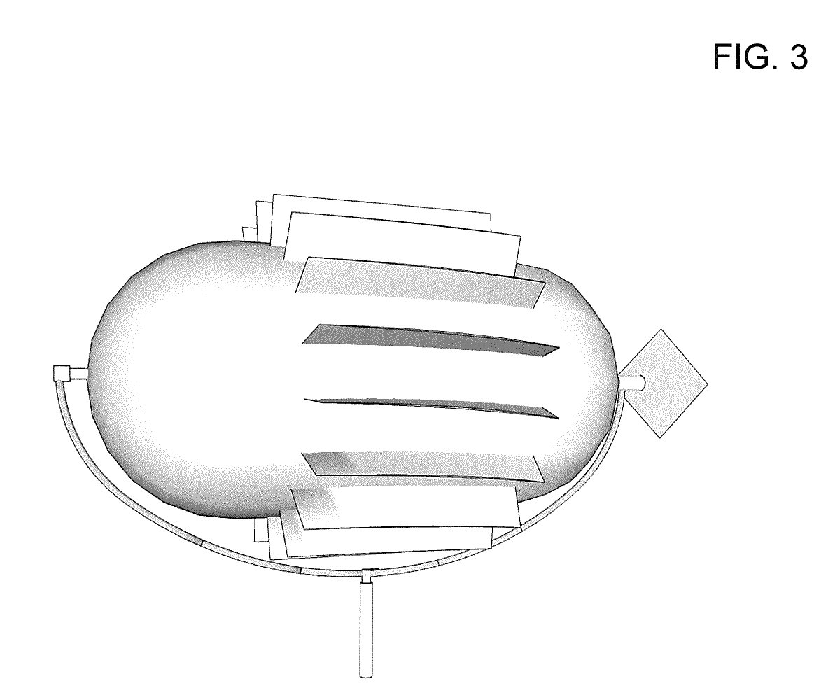

The disclosed wind turbine in exemplary embodiments may be constructed in a variety of curved shapes, such as a teardrop shape (FIG. 1), or sphere shape (FIG. 2), or torpedo shape (FIG. 3). The most efficient body shape may be an aerodynamic shape such as the teardrop shape, such as that depicted in FIG. 4.

Referring now to FIG. 1, parts of an exemplary wind turbine 100 are shown. Body 1, which can be mostly hollow, or mostly solid, or somewhere in between, has a front portion 1a adapted to face the wind, a middle portion 1b between the front portion 1a and a rear portion 1c and adapted to capture wind energy with a set of blades 2, and the rear portion 1c adapted to help direct an airflow over the rest of the body 1 and assist in steering the body 1 about a steering axis so that the front portion 1a faces the wind. The body 1 has a generally curved shape, starting at the front portion 1a, expanding in diameter about an axis of rotation to the middle portion 1b (which is configured to rotate about the axis of rotation), and then contracting in diameter to the rear portion 1c. The body 1 reacts to wind directed at its front portion 1a. The wind creates a laminar flow, which surrounds the body 1 and contacts the set of blades 2, which convert the wind energy into rotational energy (the wind turbine 100, when viewed from the front, will rotate counterclockwise) about an axle 6 (located on the axis of rotation). The axle 6 may extend through the interior of the body 1, or may be only at the ends, or somewhere in between.

The blades 2 have a generally curved (and possibly airfoil) shape, angled similarly with respect to the axis of rotation (to work together in rotating the wind turbine 100) when attached to the middle portion 1b to convert wind energy into rotational energy. Their number, lengths (protrusion from the body 1), widths (contact along the body 1), and angles (i.e., how oblique they are from the axis of rotation) can vary from one wind turbine to another, depending on factors such as the body shape and size, blade material composition, intended deployment location, etc. For instance, in some embodiments, the length of the blades is substantially that of the thickness of the laminar flow surrounding the body during normal operation.

Referring to FIG. 5, the oblique angle that the blades 2 make with respect to the axis of rotation allows them to present a cross-section to the airflow when the airflow is directed at the front portion 1a of the body 1. These cross-sections trap the laminar flow surrounding the body 1 and convert some of the wind energy to rotational energy of the body 1 (since the blades 2 are attached to the body 1), or at least the middle portion 1b of the body 1.

Some of the wind not converted into rotational energy by the blades 2 travels around the body 1 to the rear portion 1c and encounters the tail fin 3, whose shape, relatively fixed location (compared to the body 1), and symmetry about the axis of rotation help direct the front portion of the wind turbine 100 about a steering axis (for example, along the direction of pole 7 in FIG. 1) to face the wind. The steering axis, for example, may pass through the body's center of gravity. In other embodiments, the steering axis may be located in front of the body's center of gravity.

Supporting frame 4 connects to the axle 6 to support the body 1, while the pole 7 supports the frame 4 off the ground and, in combination with bearings 5b (or other suitable rotation methods or devices of the pole 7 and/or the frame 4), allows the wind turbine 100 to rotate freely about the steering axis to face the wind. Bearings 5a (or other suitable methods or devices) allow the axle 6 to rotate freely about the axis of rotation.

The described wind turbine may rotate as a whole or partially (including at least the middle portion), as shown in different embodiments in FIGS. 1-8. For example, in FIGS. 1-5, the entire body (teardrop, sphere, or torpedo shape) is configured to rotate. In other words, the body is a single rotating unit, and rotates, for example, about an axle (see axle 6 in FIG. 1) along the axis of rotation.

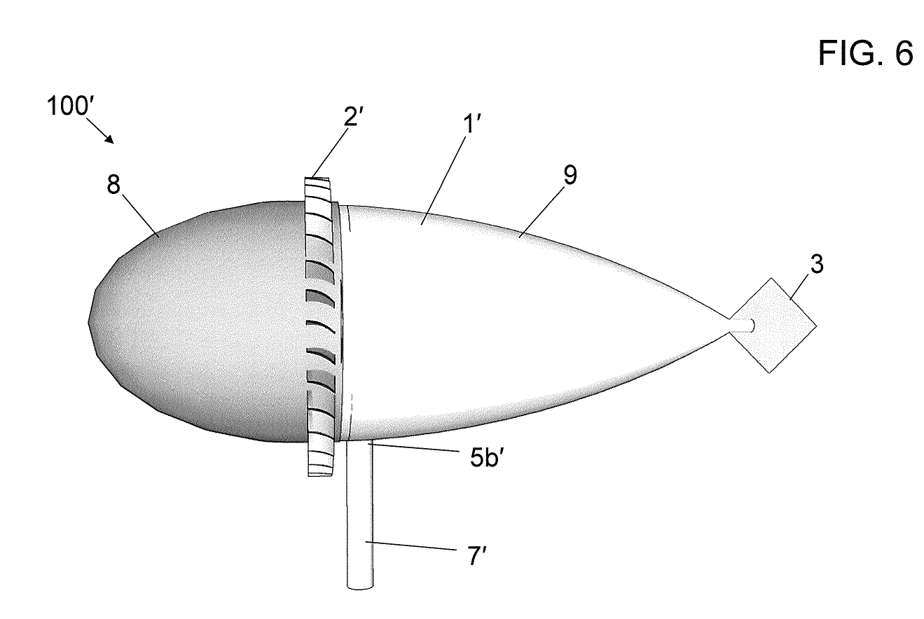

In the wind turbine 100′ of FIG. 6, on the other hand, the body 1′ is composed of two parts, a nose 8 (that includes set of blades 2′) and a tail 9, with only the nose configured to rotate. As such, the nose 8 corresponds to the front portion 1a and middle portion 1b of the wind turbine 100 of FIG. 1 while the tail 9 corresponds to the rear portion 1c. This design frees up the tail 9 to be used, for example, to support the wind turbine 100′ using pole 7′, which is configured to rotate about the steering axis through, for example, bearings 5b′ (or at some other suitable location, or other suitable methods or devices to permit rotation about the steering axis, which could be on or in the pole 7 and/or the tail 9). While the blades 2′ may be similar in shape, angle, and orientation to those used in one of the entirely rotating wind turbines of FIGS. 1-5, allowance may have to be made to not interfere with the non-rotating tail 9 or the pole 7′.

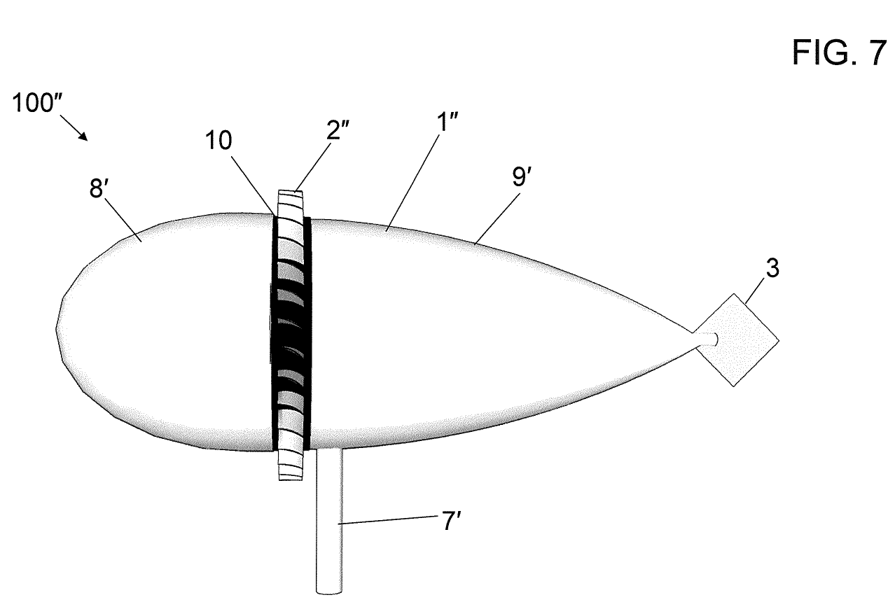

In the wind turbine 100″ of FIG. 7, the body 1″ is composed of three parts—a nose 8′, a tail 9′, and a rotating belt 10 that includes the blades 2″—with only the belt 10 being configured to rotate with the blades 2″. As such, the nose 8′ corresponds to the front portion 1a, the belt 10 corresponds to the middle portion 1b, and the tail 9′ corresponds to the rear portion 1c of the wind turbine 100 of FIG. 1. As was the case in FIG. 6, the tail 9′ may still be fixed, and attach to a pole 7′. The nose 8′, however, may be fixed, or may rotate freely, though not necessarily in synchronization with the blades 2″. While the blades 2″ may be similar in shape, angle, and orientation to those used in the two-part design in FIG. 6, further allowance may be needed to not interfere with the nose 8′.

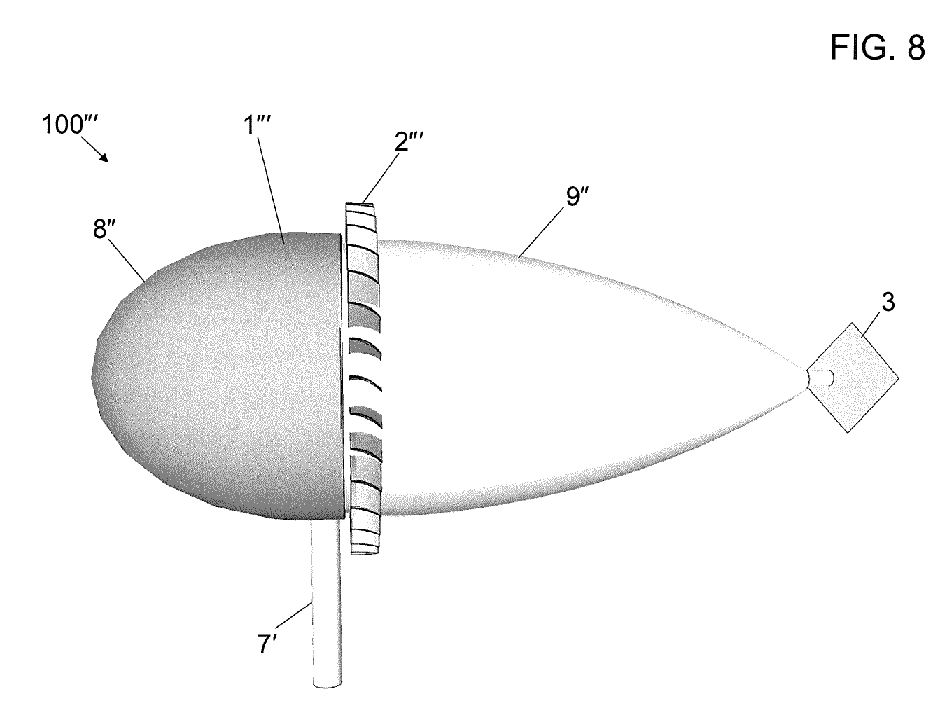

In the wind turbine 100′″ of FIG. 8, the body 1′″ is composed of two parts, a nose 8″ and a tail 9″ (that includes a set of blades 2′″), with only the tail 9″ configured to rotate. As such, the nose 8″ corresponds to the front portion 1a and the tail 9″ corresponds to the middle portion 1b and tail portion 1c of the wind turbine 100 of FIG. 1. This design frees up the nose 8″ to be used, for example, to support the wind turbine 100′″ using a pole 7′ (similar to the tail's role in the wind turbine 100′ of FIG. 6). As with FIG. 6, the blades 2′″ may be similar in shape, angle, and orientation to those of earlier embodiments, possibly making allowance to not interfere with the non-rotating nose 8″ or the pole 7′.

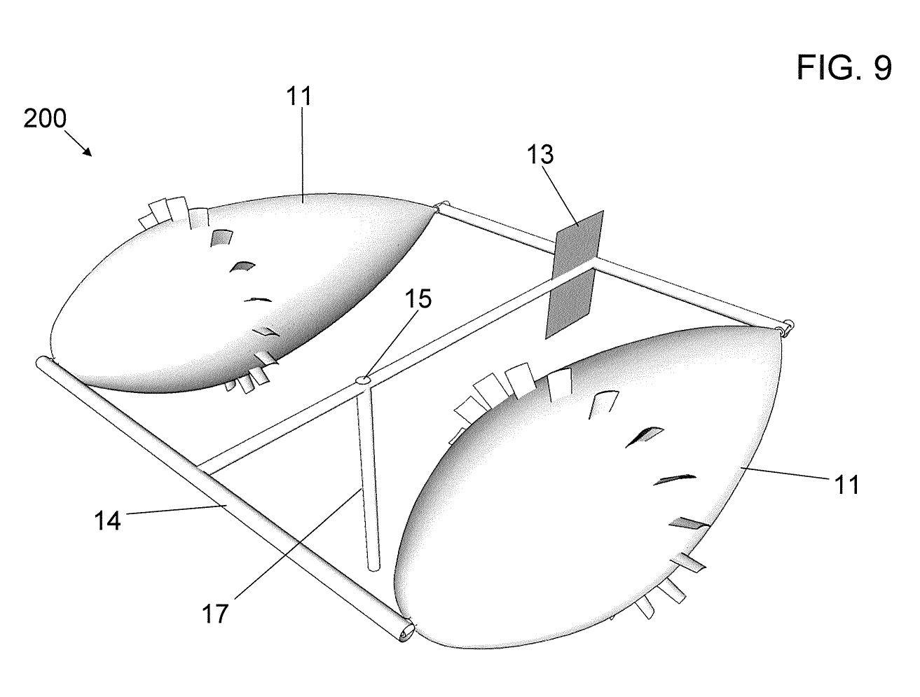

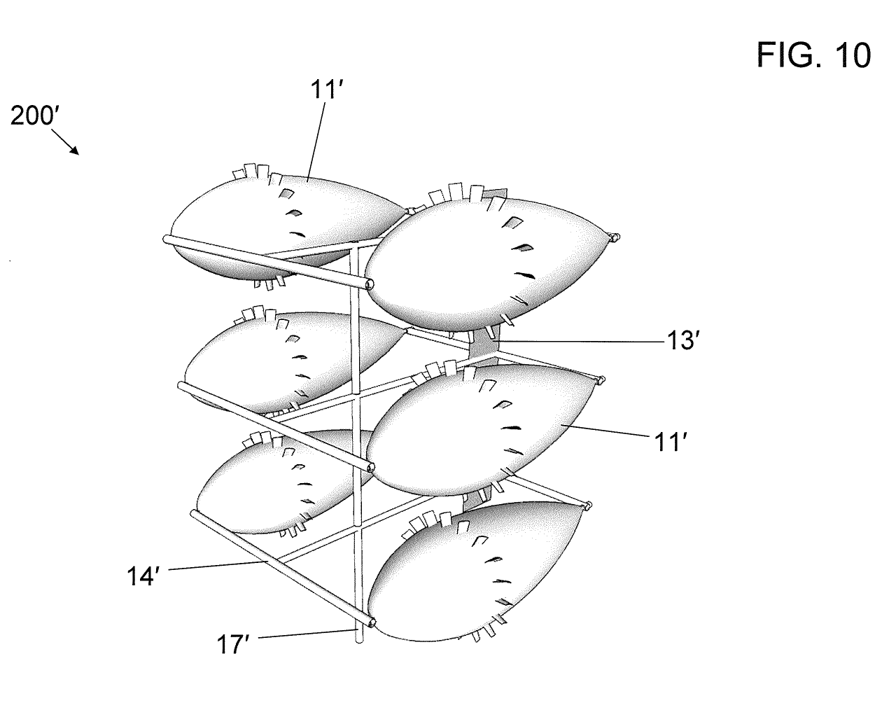

To harvest more wind energy, the wind turbine may employ multiple bodies, as shown in FIGS. 9-10, sharing a common frame and steering mechanism. In the wind turbine 200 of FIG. 9, two bodies 11 (arranged side-by-side with an interconnecting frame 14 and pole 17) and a single fin 13 on the interconnecting frame 14 are used in an exemplary embodiment of the present invention. The wind turbine 200 would be configured to rotate about the steering axis using methods or devices similar to that discussed for the single body wind turbines above (e.g., at a connection 15 between the pole 17 and the frame 14, or along the pole 17, or with a rotating pole 17, or the like). With multiple bodies, the steering axis may coincide with the center of gravity of the group of bodies. In other embodiments, the steering axis may be in front of this center of gravity.

In the wind turbine 200′ of FIG. 10, six bodies 11′ (arranged in a stacked configuration of three rows of two bodies apiece with an interconnecting frame 14′ and pole 17′) and a taller single fin 13′ on the interconnecting frame 14′ are used in another exemplary embodiment of the present invention. The fins 13 and 13′ are configured to help steer the wind turbine about a steering axis to face the wind. In these embodiments, the poles 17 and 17′ are located along the steering axes of their respective wind turbines. While the wind turbines 200 and 200′ of FIGS. 9-10 show similar bodies 11 and 11′ used throughout their respective wind turbines 200 and 200′, other embodiments may mix shapes and/or sizes of their respective bodies.

Unlike conventional wind turbines, the disclosed wind turbines according to embodiments of the present invention can be compact, lightweight, and cost effective in conditions unsuitable for conventional wind turbines. In addition, these wind turbines can require less maintenance than conventional wind turbines.

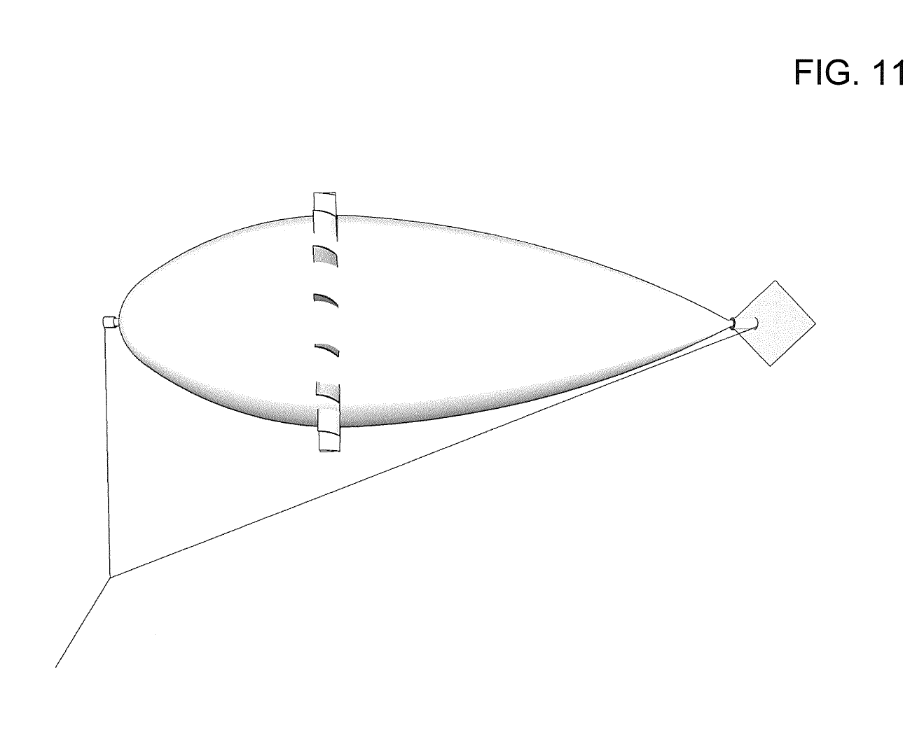

In other embodiments of the present invention (see, for example, FIG. 11), the teardrop wind turbine can be inflated with helium or other lighter-than-air gas so that it is able to float and rotate by itself in high altitude, where the wind speed is much faster. This allows still further wind power to be captured and utilized. Steel wires or cables, for example, can be used to secure such lighter-than-air wind turbines.

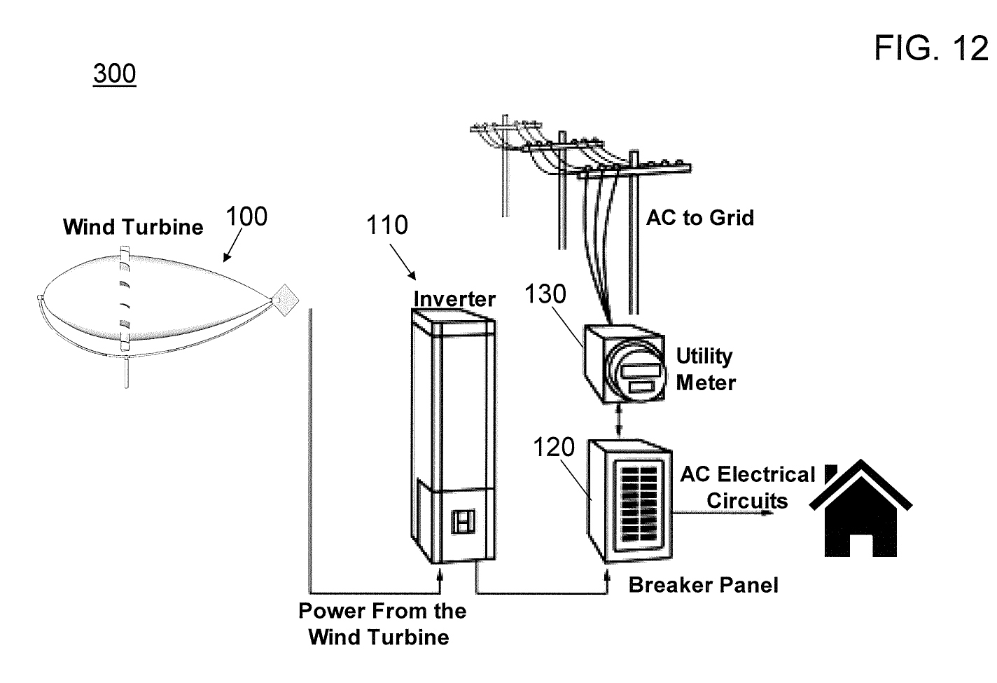

FIG. 12 shows an example wind turbine system 300 according to an embodiment of the present invention. The system 300 employs a single wind turbine 100, but other systems may employ multiple wind turbines, each with one or more bodies. Power generated from the wind turbine 100 is then converted to a suitable form. For example, the wind turbine 100 in system 300 generates direct current from the rotational motion of its body. This direct current is then directed to inverter 110, which converts the power to alternating current. The alternating current can then be used, for example, to power homes, such as through breaker panel 120, or delivered to an electric grid, say through utility meter 130. Alternate system embodiments (for example, with larger wind turbines) may generate alternating current directly, possibly converting it to direct current through the use of a rectifier in place of the inverter 110.

While the present invention has been particularly shown and described with reference to exemplary embodiments thereof, it will be understood by those of ordinary skill in the art that various changes in form and details may be made therein without departing from the spirit and scope of the present invention as defined by the following claims, and equivalents thereof.

What is claimed is:

1. A wind turbine body comprising:
a curved body comprising a front portion, a rear portion, and a middle portion between the front portion and the rear portion, the curved body configured such that at least the middle portion rotates about an axis of rotation, a diameter of the curved body gradually increasing from the front portion to the middle portion, and gradually decreasing from the middle portion to the rear portion; and
a plurality of blades attached to and around the middle portion about the axis of rotation, and configured to convert an airflow energy into rotational motion energy of the middle portion.

2. The wind turbine body of claim 1, wherein the curved body is sphere shaped.

3. The wind turbine body of claim 1, wherein the curved body is torpedo shaped.

4. The wind turbine body of claim 1, wherein the curved body is teardrop shaped.

5. The wind turbine body of claim 1, wherein the curved body is inflatable.

6. The wind turbine body of claim 5, wherein the curved body is configured to be filled with lighter-than-air gas and the middle portion is configured to rotate while floating.

7. The wind turbine body of claim 1, wherein the curved body is configured to attach to a pole.

8. The wind turbine body of claim 1, further comprising an axle along the axis of rotation.

9. The wind turbine body of claim 8, wherein the axle is configured to attach to a supporting frame.

10. The wind turbine body of claim 9, further comprising the supporting frame.

11. The wind turbine body of claim 10, wherein the supporting frame is configured to attach to a pole.

12. The wind turbine body of claim 1, wherein each of the blades has a height in a radial direction of the axis of rotation that is substantially equal to a thickness of a laminar layer at the middle portion.

13. The wind turbine body of claim 1, wherein each of the blades has a shape of an airfoil.

14. A wind turbine comprising:
a wind turbine body comprising:
a curved body comprising a front portion, a rear portion, and a middle portion between the front portion and the rear portion, the curved body configured such that at least the middle portion rotates about an axis of rotation, a diameter of the curved body gradually increasing from the front portion to the middle portion, and gradually decreasing from the middle portion to the rear portion; and
a plurality of blades attached to and around the middle portion about the axis of rotation, and configured to convert an airflow into rotational motion of the middle portion; and
a fin at the rear portion and configured to steer the wind turbine about a steering axis so that the front portion faces the airflow.

15. The wind turbine of claim 14, wherein the curved body is teardrop shaped.

16. The wind turbine of claim 14, wherein the curved body is configured to be filled with lighter-than-air gas and the middle portion is configured to rotate while floating.

17. The wind turbine of claim 14, wherein the curved body is configured to attach to a pole along the steering axis.

18. The wind turbine of claim 14, further comprising an axle along the axis of rotation.

19. The wind turbine of claim 18, wherein the axle is configured to attach to a supporting frame.

20. The wind turbine of claim 19, further comprising the supporting frame.

21. The wind turbine of claim 20, wherein the supporting frame is configured to attach to a pole along the steering axis.

22. The wind turbine of claim 14, wherein each of the blades has a height in a radial direction of the axis of rotation that is substantially equal to a thickness of a laminar layer at the middle portion.

23. The wind turbine of claim 14, wherein each of the blades has a shape of an airfoil.

24. A wind turbine comprising:
a plurality of wind turbine bodies for converting an airflow into rotational motion, each of the wind turbine bodies comprising:
a curved body comprising a front portion, a rear portion, and a middle portion between the front portion and the rear portion, the curved body configured such that at least the middle portion rotates about an axis of rotation, a diameter of the curved body gradually increasing from the front portion to the middle portion, and gradually decreasing from the middle portion to the rear portion; and
a plurality of blades attached to and around the middle portion about the axis of rotation, and configured to convert the airflow into rotational motion of the middle portion; and
an interconnecting frame for connecting the wind turbine bodies; and
a fin configured to steer the wind turbine about a steering axis so that the front portion of each of the wind turbine bodies faces the airflow.

25. The wind turbine of claim 24, wherein the fin is located on the interconnecting frame.

26. The wind turbine of claim 24, wherein the wind turbine bodies are all of a same shape and size.

27. The wind turbine of claim 26, wherein the shape is a teardrop.

28. The wind turbine of claim 24, wherein the curved body of each of the wind turbine bodies is configured to be filled with lighter-than-air gas and the middle portion of each of the wind turbine bodies is configured to rotate while floating.

29. The wind turbine of claim 24, wherein the frame is configured to attach to a pole along the steering axis.

30. The wind turbine of claim 24, wherein each of the wind turbine bodies further comprises an axle along its respective axis of rotation.

31. The wind turbine of claim 30, wherein the axle of each of the wind turbine bodies is attached to the interconnecting frame.

32. The wind turbine of claim 24, wherein each of the blades has a height in a radial direction of its respective axis of rotation that is substantially equal to a thickness of a laminar layer of its respective curved body at the middle portion.

33. The wind turbine of claim 24, wherein each of the blades has a shape of an airfoil.
